(19) United States
(12) Patent Application Publication
(10) Pub. No.: US 2025/0365711 A1
(43) Pub. Date: Nov. 27, 2025

(54) COMMUNICATION TIMING FOR IDENTIFIERS

(71) Applicant: QUALCOMM Incorporated, San Diego, CA (US)

(72) Inventors: Zhikun WU, Beijing (CN); Yuchul KIM, San Diego, CA (US); Ahmed ELSHAFIE, San Diego, CA (US); Wei YANG, San Diego, CA (US); Huilin XU, Temecula, CA (US); Yu ZHANG, San Diego, CA (US)

(21) Appl. No.: 18/873,890

(22) PCT Filed: Sep. 7, 2022
(86) PCT No.: PCT/CN2022/117449

§ 371 Date: Dec. 11, 2024

(51) Int. Cl. H04W 72/0446

(52) U.S. Cl. CPC H04W 72/0446

(57) ABSTRACT

Methods, systems, and devices for wireless communications are described. A user equipment (UE) may transmit a signal indicating a quantity of identifiers, each indicated identifier to transmit a response during a time domain window. The time domain window may include a quantity of sub-windows, where each sub-window is of equal duration. The UE may receive, from each identifier of the quantity of identifiers, a response in each sub-window, based on transmitting the signal. The time domain window may also include one or more guard time durations.

### CROSS REFERENCE

The present Application is a 371 national phase filing of International PCT Application No. PCT/CN2022/117449 by WU et al., entitled “COMMUNICATION TIMING FOR IDENTIFIERS,” filed Sep. 7, 2022, which is assigned to the assignee hereof, and which is expressly incorporated by reference in its entirety herein.

### FIELD OF TECHNOLOGY

The following relates to wireless communications, including communication timing for identifiers.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). Wireless communications system may also include one or more identifiers which may communicate with a UE.

### SUMMARY

The described techniques relate to improved methods, systems, devices, and apparatuses that support communication timing for identifiers. For example, the described techniques provide for transmitting a signal which may indicate a quantity of identifiers, each indicated identifier to transmit a response during a time domain window. The time domain window may include a quantity of sub-windows, where each sub-window is of equal duration. The described techniques may also provide for receiving, from each identifier, a response in each sub-window based on transmitting the signal, where the time domain window may include one or more guard time durations.

A method for wireless communication at a user equipment (UE) is described. The method may include transmitting a signal indicating a set of multiple identifiers, each indicated identifier to transmit a response during a time domain window, the time domain window including a set of multiple sub-windows, where each sub-window of the set of multiple sub-windows is of equal duration and receiving, from each identifier of the set of multiple identifiers, a response in each sub-window of the set of multiple sub-windows based on transmitting the signal, where the time domain window includes one or more guard time durations.

An apparatus for wireless communication at a UE is described. The apparatus may include a processor, memory coupled with the processor, and instructions stored in the memory. The instructions may be executable by the processor to cause the apparatus to transmit a signal indicating a set of multiple identifiers, each indicated identifier to transmit a response during a time domain window, the time domain window including a set of multiple sub-windows, where each sub-window of the set of multiple sub-windows is of equal duration and receive, from each identifier of the set of multiple identifiers, a response in each sub-window of the set of multiple sub-windows based on transmitting the signal, where the time domain window includes one or more guard time durations.

Another apparatus for wireless communication at a UE is described. The apparatus may include means for transmitting a signal indicating a set of multiple identifiers, each indicated identifier to transmit a response during a time domain window, the time domain window including a set of multiple sub-windows, where each sub-window of the set of multiple sub-windows is of equal duration and means for receiving, from each identifier of the set of multiple identifiers, a response in each sub-window of the set of multiple sub-windows based on transmitting the signal, where the time domain window includes one or more guard time durations.

A non-transitory computer-readable medium storing code for wireless communication at a UE is described. The code may include instructions executable by a processor to transmit a signal indicating a set of multiple identifiers, each indicated identifier to transmit a response during a time domain window, the time domain window including a set of multiple sub-windows, where each sub-window of the set of multiple sub-windows is of equal duration and receive, from each identifier of the set of multiple identifiers, a response in each sub-window of the set of multiple sub-windows based on transmitting the signal, where the time domain window includes one or more guard time durations.

Some examples of the method, apparatuses, and non-transitory computer-readable medium described herein may further include operations, features, means, or instructions for transmitting a signal indicating one or more sub-windows associated with each identifier.

In some examples of the method, apparatuses, and non-transitory computer-readable medium described herein, each identifier may be randomly associated with one or more sub-windows.

In some examples of the method, apparatuses, and non-transitory computer-readable medium described herein, receiving a response in each sub-window of the set of multiple sub-windows may include operations, features, means, or instructions for receiving a response from each identifier in a unique sub-window.

In some examples of the method, apparatuses, and non-transitory computer-readable medium described herein, two or more responses corresponding to two or more identifiers may be received in a same sub-window.

In some examples of the method, apparatuses, and non-transitory computer-readable medium described herein, two or more responses corresponding to a single identifier may be received in two or more sub-windows.

In some examples of the method, apparatuses, and non-transitory computer-readable medium described herein, the signal further indicates the duration of each sub-window.

In some examples of the method, apparatuses, and non-transitory computer-readable medium described herein, the duration of each sub-window includes a zero-power internet of things (ZP-IoT) slot.

Some examples of the method, apparatuses, and non-transitory computer-readable medium described herein may further include operations, features, means, or instructions for dividing the time domain window into a quantity of the sub-windows, where the quantity of the sub-windows may be based on a quantity of the identifiers.

Some examples of the method, apparatuses, and non-transitory computer-readable medium described herein may further include operations, features, means, or instructions for receiving a first response from a first identifier and a second response from a second identifier, where the first response and the second response at least partially overlap in time and determining the duration of each sub-window based on receiving the first response and the second response that at least partially overlap in time.

In some examples of the method, apparatuses, and non-transitory computer-readable medium described herein, the duration of each sub-window, a quantity of the sub-windows, or any combination thereof may be based on a preconfigured relationship between a duration of the time domain window and a quantity of the identifiers, receiving one or more responses that at least partially overlap in time, or any combination thereof.

In some examples of the method, apparatuses, and non-transitory computer-readable medium described herein, a guard time configuration may be associated with the one or more guard time durations.

In some examples of the method, apparatuses, and non-transitory computer-readable medium described herein, the guard time configuration may be preconfigured.

In some examples of the method, apparatuses, and non-transitory computer-readable medium described herein, the signal further indicates the guard time configuration.

In some examples of the method, apparatuses, and non-transitory computer-readable medium described herein, the guard time configuration includes a guard time duration included in each sub-window of the set of multiple sub-windows.

In some examples of the method, apparatuses, and non-transitory computer-readable medium described herein, the guard time duration occurs at the beginning of each sub-window, the end of each sub-window, or both.

In some examples of the method, apparatuses, and non-transitory computer-readable medium described herein, the guard time duration included in a sub-window may be based on a type of identifier associated with the sub-window.

In some examples of the method, apparatuses, and non-transitory computer-readable medium described herein, the type of identifier may be associated with a communication range.

In some examples of the method, apparatuses, and non-transitory computer-readable medium described herein, a first guard time duration associated with a first sub-window may be shorter than a second guard time duration associated with a subsequent second sub-window.

In some examples of the method, apparatuses, and non-transitory computer-readable medium described herein, the guard time configuration includes a guard time duration at the end of the time domain window following the set of multiple sub-windows.

In some examples of the method, apparatuses, and non-transitory computer-readable medium described herein, the guard time duration may be based on a timing offset from the signal, one or more identifier types of the set of multiple identifiers, or any combination thereof.

In some examples of the method, apparatuses, and non-transitory computer-readable medium described herein, each identifier may be a radio frequency identifier (RFID) tag.

### BRIEF DESCRIPTION OF THE DRAWINGS

FIG. 1 illustrates an example of a wireless communications system that supports communication timing for identifiers in accordance with one or more aspects of the present disclosure.

FIG. 2 illustrates an example of a system diagram that supports communication timing for identifiers in accordance with one or more aspects of the present disclosure.

FIG. 3A, 3B, and 3C each illustrate an example of a timing diagram that supports communication timing for identifiers in accordance with one or more aspects of the present disclosure.

FIG. 4 illustrates an example of a process flow in a system that supports communication timing for identifiers in accordance with one or more aspects of the present disclosure.

FIGS. 5 and 6 show block diagrams of devices that support communication timing for identifiers in accordance with one or more aspects of the present disclosure.

FIG. 7 shows a block diagram of a communications manager that supports communication timing for identifiers in accordance with one or more aspects of the present disclosure.

FIG. 8 shows a diagram of a system including a device that supports communication timing for identifiers in accordance with one or more aspects of the present disclosure.

FIGS. 9 through 11 show flowcharts illustrating methods that support communication timing for identifiers in accordance with one or more aspects of the present disclosure.

### DETAILED DESCRIPTION

Wireless communications systems (e.g., NR wireless communications systems) may include passive internet of things (IoT) devices, which may rely on passive communication technologies such as backscatter communication, which may provide for low power and low cost of devices. In some cases, wireless communications systems may include ultra-high frequency radio frequency identification (UHF RFID) systems, which may also use back scatter communications. However, UHF RFID systems may not be compatible with NR systems.

In some cases, a communication system, such as an UHF RFID system, may include one or more readers (e.g., UEs) and one or more identifiers, such as radio frequency identification (RFID) tags, which may have poor timing ability which may result in low efficiency time division multiplexing between identifiers. For example, a UE may repeatedly transmit a synchronization signal (e.g., a command) to the one or more identifiers to indicate the beginning of a slot in which an identifier may respond. However, the subsequent slots may vary in length, which may result in the identifiers continuously monitoring for the synchronization signal to indicate the beginning of a new slot. The continuous monitoring of the identifiers may increase power consumption of the identifiers, and the repetition of the synchronization signal may increase overhead and power consumption at the UE. Further which slot corresponds to each identifier may be randomly generated which may result in collisions between transmissions of multiple identifiers, such as when more than one identifier responds in a given slot. Such collisions may decrease the efficiency of the system.

In some cases, readers may be associated with an increased timing ability. In some cases, the increased timing ability may be associated with an increased power consumption, however some readers may be equipped with energy harvesting and energy storage abilities. Readers with increased timing ability may be implemented in NR systems. For example, a time domain window may be divided into equal duration sub-windows, where identifiers may respond to a synchronization signal in one or more sub-windows. Based on the equal duration sub-windows, the UE may not repeatedly transmit the synchronization signal to indicate the beginning of a sub-window. For example, the UE may transmit a single synchronization signal at the beginning of the time domain window and the identifiers may determine the beginning of each sub-window based on the equal duration of the sub-windows. Transmission of a single synchronization signal, rather than repeated transmissions, may decrease overhead and power consumption at the UE.

The duration of the sub-windows may be based on the quantity of identifiers, a type of identifier, previous collisions between identifier response transmissions, a pre-configuration, or any combination thereof. For example, the duration of the sub-windows may be preconfigured to be equal to a zero-power IoT (ZP-IoT) slot.

The time domain window may include one or more guard time durations to provide a buffer for errors related to different timing capabilities of different types of identifiers, propagation delay, or other effects. For example, a guard time duration may be included in each sub-window in the time domain window, at the end of the time domain window, or any combination thereof. The equal sub-window durations and inclusion of one or more guard time durations may decrease collisions and increase the efficiency of the system.

Aspects of the disclosure are initially described in the context of wireless communications systems. Aspects of the disclosure are also described in the context of a system diagram, timing diagrams, and a process flow. Aspects of the disclosure are further illustrated by and described with reference to apparatus diagrams, system diagrams, and flowcharts that relate to communication timing for identifiers.

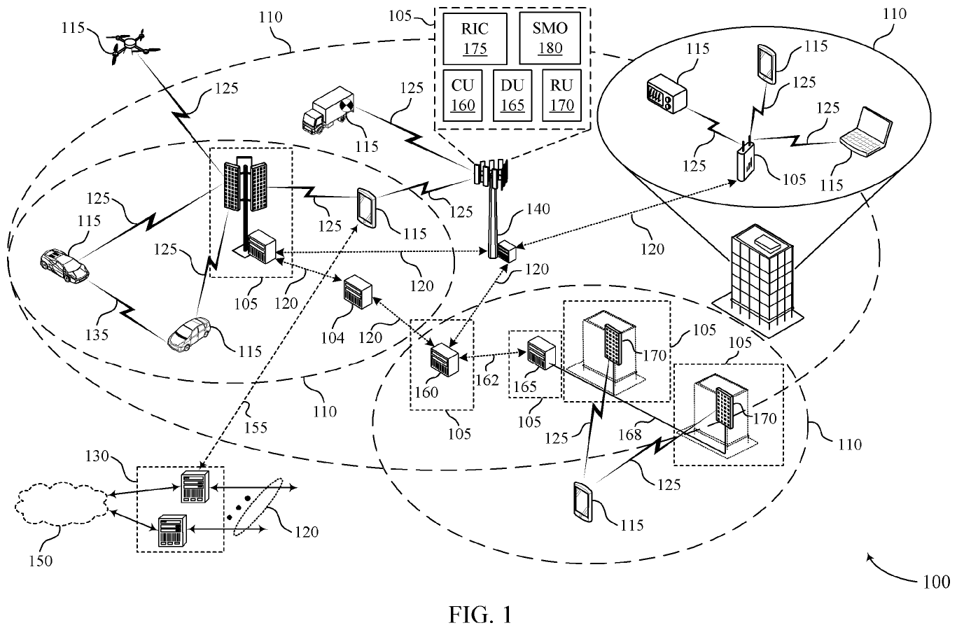

FIG. 1 illustrates an example of a wireless communications system 100 that supports communication timing for identifiers in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support communication timing for identifiers as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some cases, a communication system may include one or more readers (e.g., UEs) and one or more identifiers, such as radio frequency identification (RFID) tags, which may have poor timing ability which may result in low efficiency time division multiplexing between identifiers. For example, a UE may repeatedly transmit a synchronization signal (e.g., a command) to the one or more identifiers to indicate the beginning of a slot in which an identifier may respond. However, the subsequent slots may vary in length, which may result in the identifiers continuously monitoring for the synchronization signal to indicate the beginning of a new slot. The continuous monitoring of the identifiers may increase power consumption of the identifiers, and the repetition of the synchronization signal may increase overhead and power consumption at the UE. Further which slot corresponds to each identifier may be randomly generated which may result in collisions between transmissions of multiple identifiers, such as when more than one identifier responds in a given slot. Such collisions may decrease the efficiency of the system.

A time domain window may be divided into equal duration sub-windows, where identifiers may respond to a synchronization signal in one or more sub-windows. Based on the equal duration sub-windows, the UE may not repeatedly transmit the synchronization signal to indicate the beginning of a sub-window. For example, the UE may transmit a single synchronization signal at the beginning of the time domain window and the identifiers may determine the beginning of each sub-window based on the equal duration of the sub-windows. Transmission of a single synchronization signal, rather than repeated transmissions, may decrease overhead and power consumption at the UE. The duration of the sub-windows may be based on the quantity of identifiers, a type of identifier, previous collisions between identifier response transmissions, a pre-configuration, or any combination thereof. The time domain window may also include one or more guard time durations to provide a buffer for errors related to different timing capabilities of different types of identifiers, propagation delay, or other effects. For example, a guard time duration may be included in each sub-window in the time domain window, at the end of the time domain window, or any combination thereof. The equal sub-window durations and inclusion of one or more guard time durations may decrease collisions and increase the efficiency of the system.

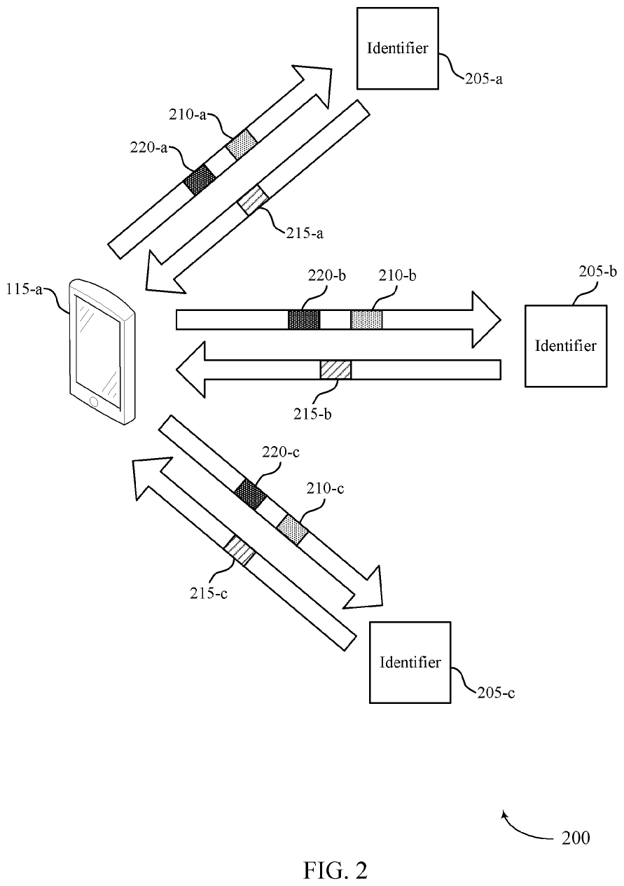

FIG. 2 illustrates an example of a wireless communication system 200 that supports communication timing for identifiers in accordance with one or more aspects of the present disclosure. In some examples, the wireless communication system 200 may implement aspects of the wireless communications system 100. For example, the wireless communications system 200 may include a UE 115-a, which may be an example of the UE 115 as described with reference to FIG. 1.

The wireless communication system 200 may also include one or more identifiers 205, such as identifier 205-a, identifier 205-b, and identifier 205-c, each of which may be an RFID tag. In some cases, the identifiers 205 may be different types or belong to different classifications (e.g., passive, semi-passive, semi-active, or active) of identifiers or tags (e.g., IoT devices). For example, some identifiers 205 may use backscatter communication, active transmission, or any combination thereof. In another example, some identifiers 205 may not have a battery, while others may have a battery (e.g., a rechargeable battery) or may harvest energy and implement energy storage circuits. Although three identifiers 205 are shown in the wireless communications system 200, the wireless communications system 200 may include any quantity of identifiers 205 (e.g., 4, 7, 12).

The UE 115-a (e.g., a reader) may transmit a signal 210 (e.g., a synchronization signal or command, such as a query command) to each of the identifiers 205. In some cases, the UE 115-a may broadcast or groupcast the signal 210. For example, the UE 115-a may transmit a signal 210-a to the identifier 205-a, a signal 210-b to the identifier 205-b, and a signal 210-c to the identifier 205-c. The signal 210 may indicate each identifier to transmit a response 215 during a time domain window. In some cases, the UE 115-a may use the responses 215 to determine a location of the associated identifier 205, a status of the associated identifier 205, or any other information. The time domain window may include a quantity of sub-windows, and each sub-window may be of an equal duration. In some cases, the signal 210 may indicate the duration of the sub-windows.

Each of the identifiers 205 may transmit responses 215 during one or more sub-windows. For example, based on the signal 210, the identifier 205-a may transmit a response 215-a during a first sub-window, the identifier 205-b may transmit a response 215-b during a second sub-window, and the identifier 205-c may transmit a response 215-c during a third sub-window.

Additionally, the time domain window may include one or more guard time durations in which an identifier 205 may not transmit a response 215, which may provide a buffer for errors related to different timing capabilities of the identifiers 205, a propagation delay, or any other effects. For example, each identifier 205 may be associated with a timing ability (e.g., based on the type or classification of identifier). Each identifier 205 may be associated with a sub-window, and the guard time duration included in the sub-window associated with an identifier 205 may be based on or related to the type or classification (e.g., the timing ability) of identifier 205. For example, an identifier 205 with a more advanced timing ability may be associated with a shorter guard time duration, while an identifier 205 with a less advanced timing ability may be associated with a longer guard time duration to prevent timing errors.

Additionally, or alternatively, each type of identifier 205 may be associated with a communication range, and the identifier 205-b may be associated with a larger range capability than the identifiers 205-a and 205-c, and may be located at a farther distance. The increased distance may be associated with a propagation delay, which may affect the timing accuracy of the response 215-b associated with the identifier 205-b. As such, a type or classification of identifier 205 associated with a larger range capability may be associated with a larger guard time duration. Based on the type or classification of identifier, and the timing capability, range capability, or any other capabilities, the identifiers 205 may be associated with different guard times. For example, the identifier 205-a may be associated a first guard time duration, while the identifier 205-b may be associated with a second guard time duration. Including one or more guard time durations in the time domain window may decrease the effect of propagation delay in the wireless communication system 200.

In some cases, the signal 210 may indicate a configuration for the one or more guard time durations included in the time domain window. For example, the signal 210 may indicate a length of a guard time duration in each sub-window, a guard time duration at the end of the time domain window, or any combination thereof.

In some cases, the UE 115-a may also transmit a signal 220 (e.g., prior to transmitting the signal 210) which may indicate one or more sub-windows associated with each identifier 205, such as the sub-window each identifier 205 should use to transmit the response 215. For example, a signal 220-a may indicate a first sub-window associated with the identifier 205-a, a signal 220-b may indicate a second sub-window associated with the identifier 205-b, and a signal 220-c may indicate a third sub-window associated with the identifier 205-c.

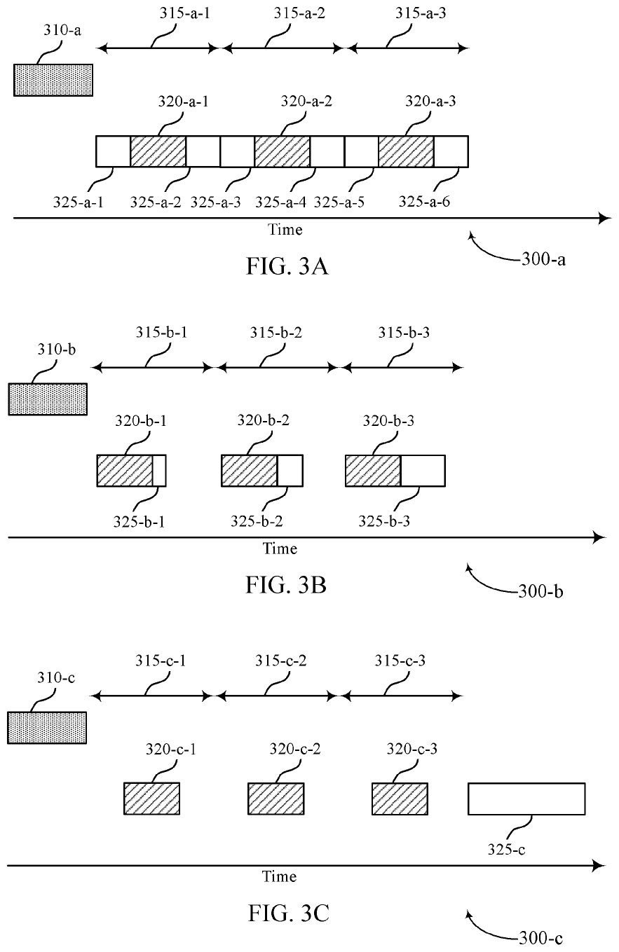

FIG. 3A illustrates an example of a timing diagram 300-a that supports communication timing for identifiers in accordance with one or more aspects of the present disclosure. The timing diagram 300-a may include a time domain window, which may be predefined or dynamically configured. The time domain window may include sub-windows 315-a, and each sub-window 315-a may be of an equal duration (e.g., the same time domain length). Although the timing diagram 300-a shows the time domain window including three sub-windows 315-a (e.g., sub-window 315-a-1, sub-window 315-a-2, and sub-window 315-a-3), the time domain window may include any quantity of sub-windows 315-a.

In some cases, the duration of the sub-windows 315-a may be based on or correspond to the quantity of identifiers. For example, the time domain window may be divided into a quantity of sub-windows, where the quantity is based on the quantity of identifiers. For example, as shown in FIG. 2, there may be three identifiers (e.g., identifiers 205). As such, the time domain window may be divided into three sub-windows 315-a, corresponding to the quantity of identifiers. The quantity of sub-windows 315-a may be based on or correspond to any quantity of identifiers. In some cases, the duration of the sub-windows 315-a may include or be equal to a zero-power internet of things (ZP-IoT) slot. In some cases, one symbol (e.g., of an NR slot) may be used by the UE to transmit a signal 310-a, and the remaining symbols in a slot may be used as sub-windows 315-a. For example, one NR slot may include fourteen symbols for ZP-IoT, and one symbol may be used to transmit the signal 310-a, while the remaining thirteen symbols may be used to transmit and receive responses 320-a.

A UE may transmit the signal 310-a (e.g., for synchronization, to provide data, or any combination thereof), which may be an example of the signal 210 (e.g., a query signal) as described with reference to FIG. 2, which may be a trigger for the identifiers to transmit responses 320-a. For example, the signal 310-a may indicate each identifier to transmit a response 320-a during the time domain window, and the UE may receive, from each identifier, a response in each sub-window 315-a. In some cases, the UE may transmit another signal (e.g., signal 220 as described with reference to FIG. 2) which may indicate to the identifiers one or more sub-windows 315-a associated with each identifier. For example, the signal may indicate that the sub-window 320-a-1 is associated with a first identifier. In other cases, each identifier may be randomly associated with one or more sub-windows 315-a.

In some cases, the UE may receive a response from each identifier in a unique sub-window 315-a, such as when each identifier is associated with a single sub-window 315-a. For example, the sub-window 315-a-1 may be associated with a first identifier, and the UE may receive a response 320-a-1 from the first identifier in the sub-window 315-a-1. Similarly, the sub-window 315-a-2 may be associated with a second identifier and the UE may receive a response 320-a-2 from the second identifier in the sub-window 315-a-2, while the sub-window 315-a-3 may be associated with a third identifier and the UE may receive a response 320-a-3 from the third identifier in the sub-window 315-a-3. In some cases, the UE may receive two or more responses corresponding to two or more identifiers in the same sub-window 315-a (e.g., the UE may be configured to receive more than one response in the same sub-window). For example, the first identifier may transmit the response 320-a-1 in the sub-window 315-a-1 and the second identifier may also transmit the response 320-a-2 in the sub-window 315-a-1. In some cases, the UE may receive two or more responses corresponding to a single identifier in two or more sub-windows. For example, both the response 320-a-1 and the response 320-a-2 may correspond to the first identifier, and the UE may receive the response 320-a-1 in the sub-window 315-a-1 and the response 320-a-2 in the sub-window 315-a-2.

In some cases, the UE may receive the response 320-a-1 from the first identifier and the response 320-a-2 from the second identifier that at least partially overlap in time (e.g., a collision based on timing inaccuracies at one or more identifiers). The UE may determine the duration (e.g., a new duration) for the sub-windows 315-a based on the two responses 320-a overlapping (e.g., in a previous communication to prevent future collisions). In some cases, the duration of each sub-window 315-a, the quantity of sub-windows 315-a, or any combination thereof may be based on a preconfigured relationship between the duration of the time domain window, the quantity of identifiers, receiving one or more responses 320-a that at least partially overlap in time, or any combination thereof. In some cases, the relationship may be configured at the UE or at a network entity (e.g., a network entity 105 as described with reference to FIG. 1, which may act as a reader).

The time domain window may also include one or more guard time durations 325-a, for example, to provide a buffer for errors related to different timing capabilities of the identifiers, timing errors, propagation delay, or any other effects. For example, the guard time durations 325-a may prevent collisions between responses 320-a. For example, an identifier may not transmit the response 320-a during a guard time duration 325-a, and may instead transmit the response 320-a during a portion of the sub-window 315-a not occupied by the guard time duration 325-a (e.g., the time duration an identifier may use to transmit a response 320-a is reduced).

The one or more guard time durations 325-a may be associated with a guard time configuration. In some cases, the guard time configuration may be preconfigured and in some cases the guard time configuration may be dynamically configured. In some cases, the signal 310-a may indicate the guard time configuration. In some cases, the guard time configuration may include a guard time duration 325-a at the beginning of each sub-window 315-a. For example, the sub-window 315-a-1 may include a guard time duration 325-a-1, the sub-window 315-a-2 may include a guard time duration 325-a-3, and the sub-window 315-a-3 may include a guard time duration 325-a-5. In some cases, the guard time configuration may include a guard time duration 325-a at the end of each sub-window 315-a. For example, the sub-window 315-a-1 may include a guard time duration 325-a-2, the sub-window 315-a-2 may include a guard time duration 325-a-4, and the sub-window 315-a-3 may include a guard time duration 325-a-6. In some cases, the guard time configuration may include a guard time duration 325-a at both the beginning and the end of each sub-window 315-a. For example, the sub-window 315-a-1 may include both the guard time duration 325-a-1 and the guard time duration 325-a-2, the sub-window 315-a-2 may include both the guard time duration 325-a-3 and the guard time duration 325-a-4, and the sub-window 315-a-3 may include both the guard time duration 325-a-5 and the guard time duration 325-a-6.

The UE may transmit another signal 310-a (e.g., after receiving the responses 320-a) to once again indicate the identifiers to transmit responses 320-a. For example, a first transmission of the signal 310-a may be a first synchronization for the UE and the identifiers, and a second transmission of the signal 310-a may be a second synchronization for the UE and the identifiers.

FIG. 3B illustrates an example of a timing diagram 300-b that supports communication timing for identifiers in accordance with one or more aspects of the present disclosure. Similar to the timing diagram 300-a as described with reference to FIG. 3A, the timing diagram 300-b may include a time domain window which may include a quantity (e.g., any quantity) of equal duration sub-windows 315-b. In the timing diagram 300-b, the UE may also transmit a signal 310-b (e.g., a synchronization signal or a trigger), and the identifiers may transmit responses 320-b.

The time domain window may also include a quantity of guard time durations 325-b. In some cases, the guard time duration 325-b may be associated with a guard time configuration, and each sub-window 315-b may be associated with a guard time duration 325-b.

In some cases, timing errors may accumulate during the time domain window. For example, a response 320-b that is farther (e.g., in the time domain) from the signal 310-b may be associated with an increased timing error. As such, the length of each guard time duration 325-b may vary in the time domain, and a sub-window 315-b that is farther from the signal 310-b may be associated with a longer guard time duration 325-b to prevent timing errors of the responses 320-b. For example, the guard time duration 325-b-1 associated with the sub-window 315-b-1 may be shorter than the guard time duration 325-b-2 associated with the sub-window 315-b-2 (e.g., the subsequent sub-window 315-b). Similarly, the guard time duration 325-b-2 associated with the sub-window 315-b-2 may be shorter than the guard time duration 325-b-3 associated with the sub-window 315-b-3. In some cases, each Nth sub-window 315-b after the signal 310-b may be associated with a guard time duration 325-b which may be increased by a factor of N. In some cases, N may be preconfigured, and in some cases, N may be dynamically configured (e.g., based on collisions or timing errors in previous response 320-b transmissions).

FIG. 3C illustrates an example of a timing diagram 300-c that supports communication timing for identifiers in accordance with one or more aspects of the present disclosure. Similar to the timing diagrams 300-a and 300-b as described with reference to FIGS. 3A and 3B, the timing diagram 300-c may include a time domain window which may include a quantity (e.g., any quantity) of equal duration sub-windows 315-c. In the timing diagram 300-c, the UE may also transmit a signal 310-c (e.g., a synchronization signal or a trigger), and the identifiers may transmit responses 320-c.

The time domain window may also include a guard time duration 325-c (e.g., based on the guard time configuration). The guard time duration 325-c may occur at the end of the time domain window following the sub-windows 315-c. The guard time duration 325-c at the end of the time domain window as a whole may isolate the responses 320-c, and any associated timing errors, from other UE transmissions and receptions that may occur at the end or after the time domain window. The length of the guard time duration 325-c may depend on a timing offset (e.g., the time elapsed) from the signal 310-c, one or more types or classifications of the identifiers, or any combination thereof. For example, a lower timing ability associated with the identifiers may increase the length of the guard time duration 325-c. Additionally, or alternatively, a longer time domain window duration may be associated with a longer length of the guard time duration 325-c.

Although the guard time duration 325-c is shown as a single guard time duration 325-c in the timing diagram 300-c, the guard time duration 325-c at the end of the time domain window as a whole may be used in addition to any of the guard time configurations described with reference to FIGS. 3A and 3B.

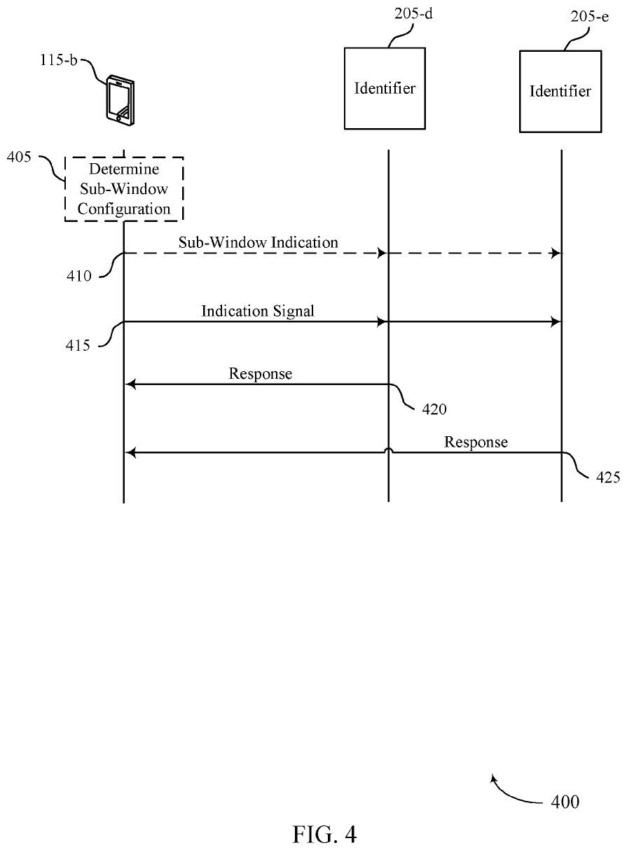

FIG. 4 illustrates an example of a process flow 400 that supports communication timing for identifiers in accordance with one or more aspects of the present disclosure. The process flow 400 may implement or be implemented at or using one or more aspects of the wireless communications systems 100 and 200, or the timing diagrams 3A, 3B, and 3C. For example, the process flow 400 may be implemented by a UE 115-b and identifiers 205-d and 205-e, which may be an example of the corresponding devices described with reference to FIGS. 1 through 3. Although the process flow 400 is shown with two identifiers 205, the process flow 400 may be implemented by any quantity of identifiers 205. In the following description of the process flow 400, the operations may occur in a different order than the example order shown, or some operations may be omitted.

In some cases, at 405, the UE 115-b may determine a sub-window configuration. For example, as described with reference to FIGS. 3A through 3C, a time domain window may include a quantity of equal duration sub-windows. In some cases, the UE 115-b may determine the quantity of sub-windows. In some cases, the UE 115-b may divide the time domain window into a quantity of sub-windows based on the quantity of identifiers 205. In some cases, the UE 115-b may determine the sub-window configuration based on a previous collision between response transmissions from two or more identifiers 205. In some cases, the duration of each sub-window, a quantity of the sub-windows, or any combination thereof may be based on a relationship (e.g., a preconfigured relationship) between the duration of the time domain window, the quantity of identifiers, receiving one or more responses that at least partially overlap in time, or any combination thereof. In some cases, the UE 115-b may determine an association between the sub-windows and the identifiers 205. For example, the UE 115-b may associate one or more sub-windows with each identifier 205. In some cases, each identifier may be randomly associated with one or more sub-windows, and the association may be determined by the UE 115-b, by the associated identifier 205, or any combination thereof.

In some cases, at 410, the UE 115-b may transmit, and the identifier 205-d and the identifier 205-e may receive, a signal including a sub-window indication. For example, the signal may indicate one or more sub-windows associated with each identifier 205. For example, the signal may indicate that the identifier 205-d is associated with a first sub-window, while the identifier 205-e is associated with a second sub-window. In some cases, the sub-window indication may be based on the determined sub-window configuration at 405.

At 415, the UE 115-b may transmit and the identifier 205-d and the identifier 205-e may receive, a signal, which may be an example of the signal 210 as described with reference to FIG. 2 and an example of the signals 310-a, 310-b, and 310-c as described with reference to FIGS. 3A, 3B, and 3C. The signal may be an indication signal, a synchronization signal, a trigger, or any combination thereof which may indicate the identifiers 205 to transmit a response. In some cases, the signal may include additional information such as the duration of each sub-window, a guard time configuration, or any combination thereof.

At 420, the identifier 205-d may transmit, and the UE 115-b may receive, a response. For example, the identifier 205-d may transmit the response in a sub-window corresponding to the identifier 205-d. In some cases, the transmission may depend on a guard time configuration.

At 425, the identifier 205-e may transmit, and the UE 115-b may receive, a response. For example, the identifier 205-e may transmit the response in a sub-window corresponding to the identifier 205-e, and the transmission may depend on a guard time configuration. In some cases, the UE 115-b may receive the response at 420 and the response at 425 in unique sub-windows. For example, the UE 115-b may only receive on response in any given sub-window.

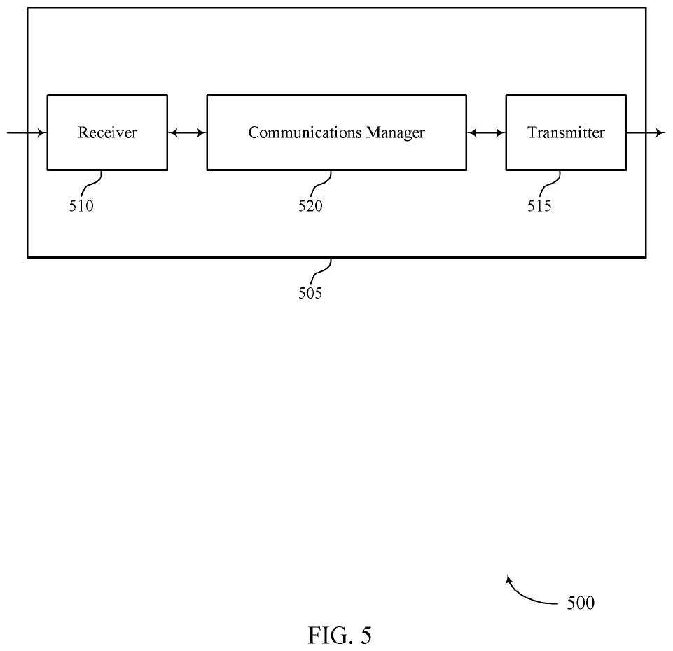

FIG. 5 shows a block diagram 500 of a device 505 that supports communication timing for identifiers in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to communication timing for identifiers). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to communication timing for identifiers). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of communication timing for identifiers as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a UE in accordance with examples as disclosed herein. For example, the communications manager 520 may be configured as or otherwise support a means for transmitting a signal indicating a set of multiple identifiers, each indicated identifier to transmit a response during a time domain window, the time domain window including a set of multiple sub-windows, where each sub-window of the set of multiple sub-windows is of equal duration. The communications manager 520 may be configured as or otherwise support a means for receiving, from each identifier of the set of multiple identifiers, a response in each sub-window of the set of multiple sub-windows based on transmitting the signal, where the time domain window includes one or more guard time durations.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for reduced processing and reduced power consumption.

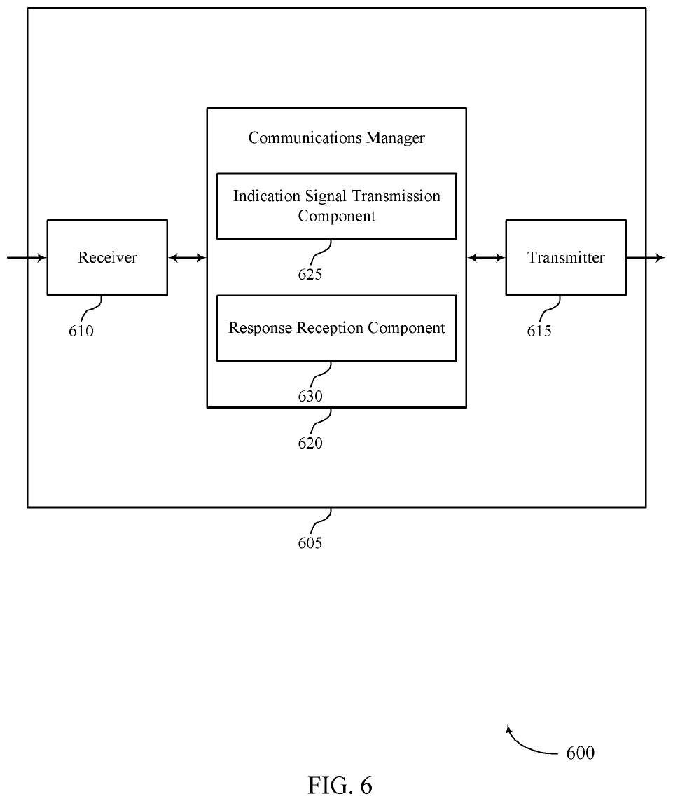

FIG. 6 shows a block diagram 600 of a device 605 that supports communication timing for identifiers in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to communication timing for identifiers). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to communication timing for identifiers). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of communication timing for identifiers as described herein. For example, the communications manager 620 may include an indication signal transmission component 625 a response reception component 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. The indication signal transmission component 625 may be configured as or otherwise support a means for transmitting a signal indicating a set of multiple identifiers, each indicated identifier to transmit a response during a time domain window, the time domain window including a set of multiple sub-windows, where each sub-window of the set of multiple sub-windows is of equal duration. The response reception component 630 may be configured as or otherwise support a means for receiving, from each identifier of the set of multiple identifiers, a response in each sub-window of the set of multiple sub-windows based on transmitting the signal, where the time domain window includes one or more guard time durations.

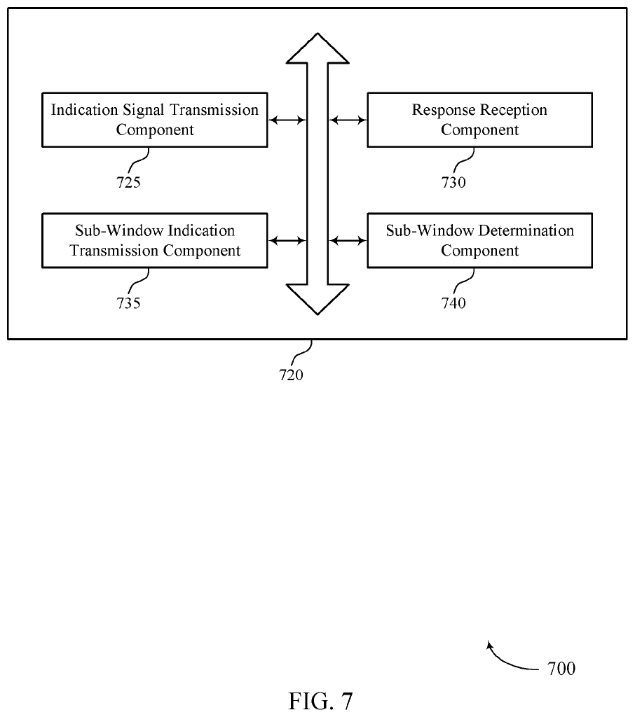

FIG. 7 shows a block diagram 700 of a communications manager 720 that supports communication timing for identifiers in accordance with one or more aspects of the present disclosure. The communications manager 720 may be an example of aspects of a communications manager 520, a communications manager 620, or both, as described herein. The communications manager 720, or various components thereof, may be an example of means for performing various aspects of communication timing for identifiers as described herein. For example, the communications manager 720 may include an indication signal transmission component 725, a response reception component 730, a sub-window indication transmission component 735, a sub-window determination component 740, or any combination thereof. Each of these components may communicate, directly or indirectly, with one another (e.g., via one or more buses).

The communications manager 720 may support wireless communication at a UE in accordance with examples as disclosed herein. The indication signal transmission component 725 may be configured as or otherwise support a means for transmitting a signal indicating a set of multiple identifiers, each indicated identifier to transmit a response during a time domain window, the time domain window including a set of multiple sub-windows, where each sub-window of the set of multiple sub-windows is of equal duration. The response reception component 730 may be configured as or otherwise support a means for receiving, from each identifier of the set of multiple identifiers, a response in each sub-window of the set of multiple sub-windows based on transmitting the signal, where the time domain window includes one or more guard time durations.

In some examples, the sub-window indication transmission component 735 may be configured as or otherwise support a means for transmitting a signal indicating one or more sub-windows associated with each identifier.

In some examples, each identifier is randomly associated with one or more sub-windows.

In some examples, to support receiving a response in each sub-window of the set of multiple sub-windows, the response reception component 730 may be configured as or otherwise support a means for receiving a response from each identifier in a unique sub-window.

In some examples, two or more responses corresponding to two or more identifiers are received in a same sub-window.

In some examples, two or more responses corresponding to a single identifier are received in two or more sub-windows.

In some examples, the signal further indicates the duration of each sub-window.

In some examples, the duration of each sub-window includes a zero-power internet of things (ZP-IoT) slot.

In some examples, the sub-window determination component 740 may be configured as or otherwise support a means for dividing the time domain window into a quantity of the sub-windows, where the quantity of the sub-windows is based on a quantity of the identifiers.

In some examples, the response reception component 730 may be configured as or otherwise support a means for receiving a first response from a first identifier and a second response from a second identifier, where the first response and the second response at least partially overlap in time. In some examples, the sub-window determination component 740 may be configured as or otherwise support a means for determining the duration of each sub-window based on receiving the first response and the second response that at least partially overlap in time.

In some examples, the duration of each sub-window, a quantity of the sub-windows, or any combination thereof is based on a preconfigured relationship between a duration of the time domain window and a quantity of the identifiers, receiving one or more responses that at least partially overlap in time, or any combination thereof.

In some examples, a guard time configuration is associated with the one or more guard time durations.

In some examples, the guard time configuration is preconfigured.

In some examples, the signal further indicates the guard time configuration.

In some examples, the guard time configuration includes a guard time duration included in each sub-window of the set of multiple sub-windows.

In some examples, the guard time duration occurs at a beginning of each sub-window, an end of each sub-window, or both.

In some examples, the guard time duration included in a sub-window is based on a type of identifier associated with the sub-window.

In some examples, the type of identifier is associated with a communication range.

In some examples, a first guard time duration associated with a first sub-window is shorter than a second guard time duration associated with a subsequent second sub-window.

In some examples, the guard time configuration includes a guard time duration at an end of the time domain window following the set of multiple sub-windows.

In some examples, the guard time duration is based on a timing offset from the signal, one or more identifier types of the set of multiple identifiers, or any combination thereof.

In some examples, each identifier is a radio frequency identifier (RFID) tag.

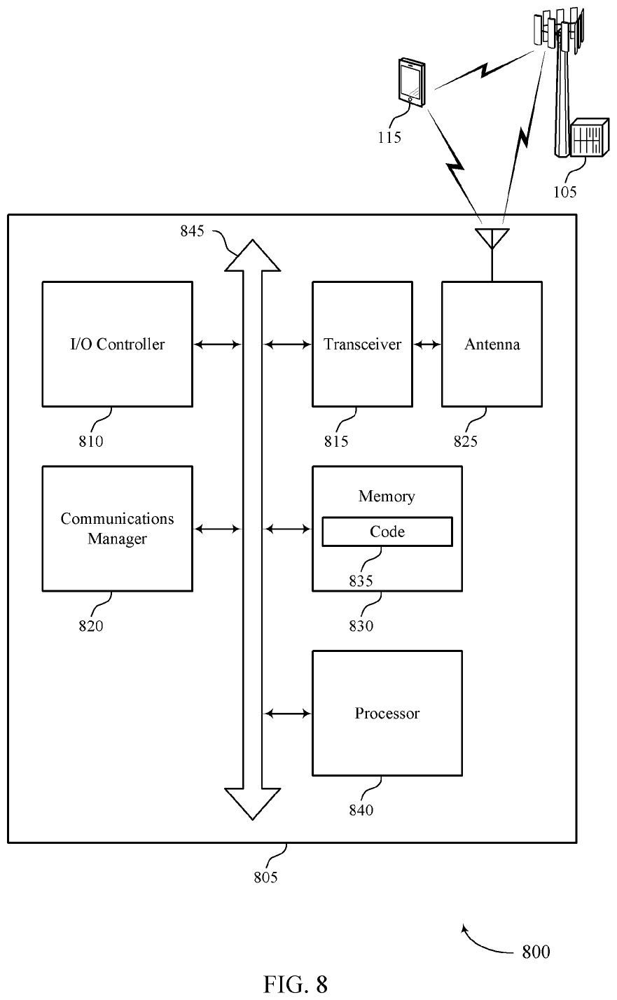

FIG. 8 shows a diagram of a system 800 including a device 805 that supports communication timing for identifiers in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting communication timing for identifiers). For example, the device 805 or a component of the device 805 may include a processor 840 and memory 830 coupled with or to the processor 840, the processor 840 and memory 830 configured to perform various functions described herein.

The communications manager 820 may support wireless communication at a UE in accordance with examples as disclosed herein. For example, the communications manager 820 may be configured as or otherwise support a means for transmitting a signal indicating a set of multiple identifiers, each indicated identifier to transmit a response during a time domain window, the time domain window including a set of multiple sub-windows, where each sub-window of the set of multiple sub-windows is of equal duration. The communications manager 820 may be configured as or otherwise support a means for receiving, from each identifier of the set of multiple identifiers, a response in each sub-window of the set of multiple sub-windows based on transmitting the signal, where the time domain window includes one or more guard time durations.

By including or configuring the communications manager 820 in accordance with examples as described herein, the device 805 may support techniques for improved communication reliability, reduced power consumption, improved coordination between devices, longer battery life, and improved utilization of processing capability.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of communication timing for identifiers as described herein, or the processor 840 and the memory 830 may be otherwise configured to perform or support such operations.

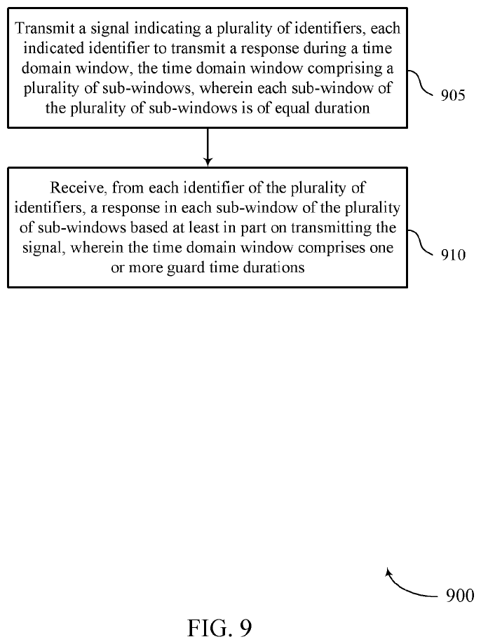

FIG. 9 shows a flowchart illustrating a method 900 that supports communication timing for identifiers in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include transmitting a signal indicating a set of multiple identifiers, each indicated identifier to transmit a response during a time domain window, the time domain window including a set of multiple sub-windows, where each sub-window of the set of multiple sub-windows is of equal duration. The operations of 905 may be performed in accordance with examples as disclosed herein. In some examples, aspects of the operations of 905 may be performed by an indication signal transmission component 725 as described with reference to FIG. 7.

At 910, the method may include receiving, from each identifier of the set of multiple identifiers, a response in each sub-window of the set of multiple sub-windows based on transmitting the signal, where the time domain window includes one or more guard time durations. The operations of 910 may be performed in accordance with examples as disclosed herein. In some examples, aspects of the operations of 910 may be performed by a response reception component 730 as described with reference to FIG. 7.

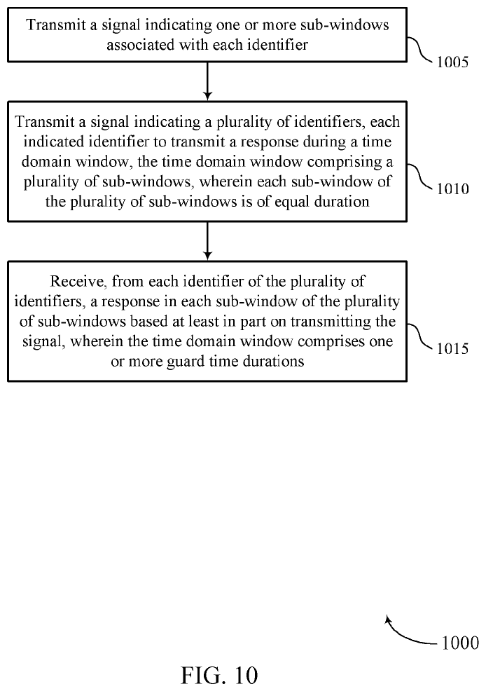

FIG. 10 shows a flowchart illustrating a method 1000 that supports communication timing for identifiers in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include transmitting a signal indicating one or more sub-windows associated with each identifier. The operations of 1005 may be performed in accordance with examples as disclosed herein. In some examples, aspects of the operations of 1005 may be performed by a sub-window indication transmission component 735 as described with reference to FIG. 7.

At 1010, the method may include transmitting a signal indicating a set of multiple identifiers, each indicated identifier to transmit a response during a time domain window, the time domain window including a set of multiple sub-windows, where each sub-window of the set of multiple sub-windows is of equal duration. The operations of 1010 may be performed in accordance with examples as disclosed herein. In some examples, aspects of the operations of 1010 may be performed by an indication signal transmission component 725 as described with reference to FIG. 7.

At 1015, the method may include receiving, from each identifier of the set of multiple identifiers, a response in each sub-window of the set of multiple sub-windows based on transmitting the signal, where the time domain window includes one or more guard time durations. The operations of 1015 may be performed in accordance with examples as disclosed herein. In some examples, aspects of the operations of 1015 may be performed by a response reception component 730 as described with reference to FIG. 7.

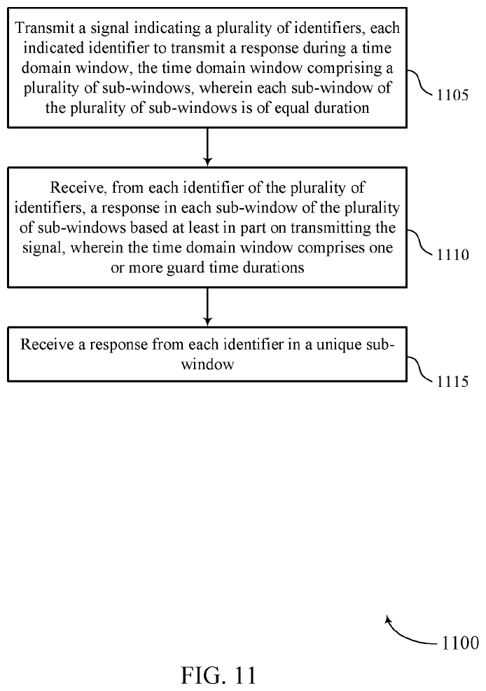

FIG. 11 shows a flowchart illustrating a method 1100 that supports communication timing for identifiers in accordance with one or more aspects of the present disclosure. The operations of the method 1100 may be implemented by a UE or its components as described herein. For example, the operations of the method 1100 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1105, the method may include transmitting a signal indicating a set of multiple identifiers, each indicated identifier to transmit a response during a time domain window, the time domain window including a set of multiple sub-windows, where each sub-window of the set of multiple sub-windows is of equal duration. The operations of 1105 may be performed in accordance with examples as disclosed herein. In some examples, aspects of the operations of 1105 may be performed by an indication signal transmission component 725 as described with reference to FIG. 7.

At 1110, the method may include receiving, from each identifier of the set of multiple identifiers, a response in each sub-window of the set of multiple sub-windows based on transmitting the signal, where the time domain window includes one or more guard time durations. The operations of 1110 may be performed in accordance with examples as disclosed herein. In some examples, aspects of the operations of 1110 may be performed by a response reception component 730 as described with reference to FIG. 7.

At 1115, the method may include receiving a response from each identifier in a unique sub-window. The operations of 1115 may be performed in accordance with examples as disclosed herein. In some examples, aspects of the operations of 1115 may be performed by a response reception component 730 as described with reference to FIG. 7.

The following provides an overview of aspects of the present disclosure:

Aspect 1: A method for wireless communication at a UE, comprising: transmitting a signal indicating a plurality of identifiers, each indicated identifier to transmit a response during a time domain window, the time domain window comprising a plurality of sub-windows, wherein each sub-window of the plurality of sub-windows is of equal duration; receiving, from each identifier of the plurality of identifiers, a response in each sub-window of the plurality of sub-windows based at least in part on transmitting the signal, wherein the time domain window comprises one or more guard time durations.

Aspect 2: The method of aspect 1, further comprising: transmitting a signal indicating one or more sub-windows associated with each identifier.

Aspect 3: The method of any of aspects 1 through 2, wherein each identifier is randomly associated with one or more sub-windows.

Aspect 4: The method of any of aspects 1 through 3, wherein receiving a response in each sub-window of the plurality of sub-windows further comprises: receiving a response from each identifier in a unique sub-window.

Aspect 5: The method of any of aspects 1 through 4, wherein two or more responses corresponding to two or more identifiers are received in a same sub-window.

Aspect 6: The method of any of aspects 1 through 5, wherein two or more responses corresponding to a single identifier are received in two or more sub-windows.

Aspect 7: The method of any of aspects 1 through 6, wherein the signal further indicates the duration of each sub-window.

Aspect 8: The method of any of aspects 1 through 7, wherein the duration of each sub-window comprises a zero-power internet of things (ZP-IoT) slot.

Aspect 9: The method of any of aspects 1 through 8, further comprising: dividing the time domain window into a quantity of the sub-windows, wherein the quantity of the sub-windows is based at least in part on a quantity of the identifiers.

Aspect 10: The method of any of aspects 1 through 9, further comprising: receiving a first response from a first identifier and a second response from a second identifier, wherein the first response and the second response at least partially overlap in time; determining the duration of each sub-window based at least in part on receiving the first response and the second response that at least partially overlap in time.

Aspect 11: The method of any of aspects 1 through 10, wherein the duration of each sub-window, a quantity of the sub-windows, or any combination thereof is based at least in part on a preconfigured relationship between a duration of the time domain window and a quantity of the identifiers, receiving one or more responses that at least partially overlap in time, or any combination thereof.

Aspect 12: The method of any of aspects 1 through 11, wherein a guard time configuration is associated with the one or more guard time durations.

Aspect 13: The method of aspect 12, wherein the guard time configuration is preconfigured.

Aspect 14: The method of any of aspects 12 through 13, wherein the signal further indicates the guard time configuration.

Aspect 15: The method of any of aspects 12 through 14, wherein the guard time configuration comprises a guard time duration included in each sub-window of the plurality of sub-windows.

Aspect 16: The method of aspect 15, wherein the guard time duration occurs at the beginning of each sub-window, the end of each sub-window, or both.

Aspect 17: The method of any of aspects 15 through 16, wherein the guard time duration included in a sub-window is based at least in part on a type of identifier associated with the sub-window.

Aspect 18: The method of aspect 17, wherein the type of identifier is associated with a communication range.

Aspect 19: The method of any of aspects 15 through 18, wherein a first guard time duration associated with a first sub-window is shorter than a second guard time duration associated with a subsequent second sub-window.

Aspect 20: The method of any of aspects 12 through 19, wherein the guard time configuration comprises a guard time duration at the end of the time domain window following the plurality of sub-windows.

Aspect 21: The method of aspect 20, wherein the guard time duration is based at least in part on a timing offset from the signal, one or more identifier types of the plurality of identifiers, or any combination thereof.

Aspect 22: The method of any of aspects 1 through 21, wherein each identifier is a radio frequency identifier (RFID) tag.

Aspect 23: An apparatus for wireless communication at a UE, comprising a processor; memory coupled with the processor; and instructions stored in the memory and executable by the processor to cause the apparatus to perform a method of any of aspects 1 through 22.

Aspect 24: An apparatus for wireless communication at a UE, comprising at least one means for performing a method of any of aspects 1 through 22.

Aspect 25: A non-transitory computer-readable medium storing code for wireless communication at a UE, the code comprising instructions executable by a processor to perform a method of any of aspects 1 through 22.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processor;
memory coupled with the processor; and
instructions stored in the memory and executable by the processor to cause the apparatus to:
transmit a signal indicating a plurality of identifiers, each indicated identifier to transmit a response during a time domain window, the time domain window comprising a plurality of sub-windows, wherein each sub-window of the plurality of sub-windows is of equal duration; and
receive, from each identifier of the plurality of identifiers, a response in each sub-window of the plurality of sub-windows based at least in part on transmitting the signal, wherein the time domain window comprises one or more guard time durations.

2. The apparatus of claim 1, wherein the instructions are further executable by the processor to cause the apparatus to:
transmit a signal indicating one or more sub-windows associated with each identifier.

3. The apparatus of claim 1, wherein each identifier is randomly associated with one or more sub-windows.

4. The apparatus of claim 1, wherein the instructions to receive a response in each sub-window of the plurality of sub-windows are further executable by the processor to cause the apparatus to:
receive a response from each identifier in a unique sub-window.

5. The apparatus of claim 1, wherein two or more responses corresponding to two or more identifiers are received in a same sub-window.

6. The apparatus of claim 1, wherein two or more responses corresponding to a single identifier are received in two or more sub-windows.

7. The apparatus of claim 1, wherein the signal further indicates the duration of each sub-window.

8. The apparatus of claim 1, wherein the duration of each sub-window comprises a zero-power internet of things (ZP-IoT) slot.

9. The apparatus of claim 1, wherein the instructions are further executable by the processor to cause the apparatus to:
divide the time domain window into a quantity of the sub-windows, wherein the quantity of the sub-windows is based at least in part on a quantity of the identifiers.

10. The apparatus of claim 1, wherein the instructions are further executable by the processor to cause the apparatus to:
receive a first response from a first identifier and a second response from a second identifier, wherein the first response and the second response at least partially overlap in time; and
determine the duration of each sub-window based at least in part on receiving the first response and the second response that at least partially overlap in time.

11. The apparatus of claim 1, wherein the duration of each sub-window, a quantity of the sub-windows, or any combination thereof is based at least in part on a preconfigured relationship between a duration of the time domain window and a quantity of the identifiers, receiving one or more responses that at least partially overlap in time, or any combination thereof.

12. The apparatus of claim 1, wherein a guard time configuration is associated with the one or more guard time durations.

13. The apparatus of claim 12, wherein the guard time configuration is preconfigured.

14. The apparatus of claim 12, wherein the signal further indicates the guard time configuration.

15. The apparatus of claim 12, wherein the guard time configuration comprises a guard time duration included in each sub-window of the plurality of sub-windows.

16. The apparatus of claim 15, wherein the guard time duration occurs at a beginning of each sub-window, an end of each sub-window, or both.

17. The apparatus of claim 15, wherein the guard time duration included in a sub-window is based at least in part on a type of identifier associated with the sub-window.

18. The apparatus of claim 17, wherein the type of identifier is associated with a communication range.

19. The apparatus of claim 15, wherein a first guard time duration associated with a first sub-window is shorter than a second guard time duration associated with a subsequent second sub-window.

20. The apparatus of claim 12, wherein the guard time configuration comprises a guard time duration at an end of the time domain window following the plurality of sub-windows.

21. The apparatus of claim 20, wherein the guard time duration is based at least in part on a timing offset from the signal, one or more identifier types of the plurality of identifiers, or any combination thereof.

22. The apparatus of claim 1, wherein each identifier is a radio frequency identifier (RFID) tag.

23. A method for wireless communication at a user equipment (UE), comprising:
transmitting a signal indicating a plurality of identifiers, each indicated identifier to transmit a response during a time domain window, the time domain window comprising a plurality of sub-windows, wherein each sub-window of the plurality of sub-windows is of equal duration; and
receiving, from each identifier of the plurality of identifiers, a response in each sub-window of the plurality of sub-windows based at least in part on transmitting the signal, wherein the time domain window comprises one or more guard time durations.

24. The method of claim 23, further comprising:
transmitting a signal indicating one or more sub-windows associated with each identifier.

25. The method of claim 23, wherein receiving a response in each sub-window of the plurality of sub-windows further comprises:
receiving a response from each identifier in a unique sub-window.

26. The method of claim 23, wherein the signal further indicates the duration of each sub-window.

27. The method of claim 23, wherein a guard time configuration is associated with the one or more guard time durations.

28. The method of claim 27, wherein the signal further indicates the guard time configuration.

29. An apparatus for wireless communication at a user equipment (UE), comprising:
means for transmitting a signal indicating a plurality of identifiers, each indicated identifier to transmit a response during a time domain window, the time domain window comprising a plurality of sub-windows, wherein each sub-window of the plurality of sub-windows is of equal duration; and
means for receiving, from each identifier of the plurality of identifiers, a response in each sub-window of the plurality of sub-windows based at least in part on transmitting the signal, wherein the time domain window comprises one or more guard time durations.

30. A non-transitory computer-readable medium storing code for wireless communication at a user equipment (UE), the code comprising instructions executable by a processor to:
transmit a signal indicating a plurality of identifiers, each indicated identifier to transmit a response during a time domain window, the time domain window comprising a plurality of sub-windows, wherein each sub-window of the plurality of sub-windows is of equal duration; and
receive, from each identifier of the plurality of identifiers, a response in each sub-window of the plurality of sub-windows based at least in part on transmitting the signal, wherein the time domain window comprises one or more guard time durations.
